(19) United States
(12) Patent Application Publication
(10) Pub. No.: US 2025/0035789 A1
(43) Pub. Date: Jan. 30, 2025

(54) LIDAR DETECTION METHOD, DEVICE, STORAGE MEDIUM, AND LIDAR

(71) Applicant: SUTENG INNOVATION TECHNOLOGY CO., LTD., Shenzhen (CN)

(72) Inventors: Chao PAN, Shenzhen (CN); Yulu XUE, Shenzhen (CN)

(73) Assignee: SUTENG INNOVATION TECHNOLOGY CO., LTD., Shenzhen (CN)

(21) Appl. No.: 18/780,474

(22) Filed: Jul. 23, 2024

(30) Foreign Application Priority Data
Jul. 25, 2023 (CN) 202310922869.0

(51) Int. Cl. G01S 17/89; G01S 7/481; G06T 7/521

(52) U.S. Cl. CPC G01S 17/89; G01S 7/4817; G06T 7/521; G06T 2207/10028

(57) ABSTRACT

Embodiments of this application disclose a method, device, storage medium, and LiDAR for LiDAR detection. The method includes: obtaining point cloud data corresponding to an i−1^{th} ground line and point cloud data corresponding to an i−2^{th} ground line; calculating a predicted height range of the i^{th} ground line based on the point cloud data corresponding to the i−1^{th} ground line and the point cloud data corresponding to the i−2^{th} ground line; detecting a scanning points on the i^{th} row of the scanning line based on the predicted height range to determine a target point in the scanning points; and obtaining the i^{th} ground line based on the target point.

### CROSS-REFERENCE TO RELATED APPLICATION

The present application claims the benefit of priority to Chinese Patent Application No. 202310922869.0, filed on Jul. 25, 2023, which is hereby incorporated by reference in its entirety.

### TECHNICAL FIELD

This application pertains to the technical field of Lidar, in particular to a Lidar detection method, device, storage medium and LiDAR.

### TECHNICAL BACKGROUND

In the fields of smart transportation and autonomous driving, perceiving the road environment and the surrounding environment of autonomous vehicles is important. This perception is based on the road information, vehicle position information, and obstacle information obtained by sensor devices such as LiDAR. The autonomous vehicles use this information to control themselves, adjust the safe distance between vehicles, and ensure safe and reliable driving on the road.

When a LiDAR is applied in the field of autonomous driving or assisted driving, detecting the road or ground is a crucial function. A LiDAR uses laser scanning to obtain the shape of the road or ground. The ground detected by LiDAR through laser scanning is presented in the form of ground lines, that is, the ground detected by LiDAR consists of lines. Therefore, the clarity and stability of the ground lines determine whether the LiDAR's ground detection is accurate.

### SUMMARY

Embodiments of this application provide a LiDAR detection method, device, computer storage medium, and LiDAR. By comparing the point cloud data corresponding to the i−1^{th} ground line and the point cloud data corresponding to the i−2^{th} ground line, which are closer to the LiDAR than the i^{th} ground line to be generated, more reliable ground points on the i^{th} row of the scanning line are selected to obtain the i^{th} ground line based on the fitted heights of the more reliable ground points, thereby improving the clarity of the i^{th} ground line.

In a first aspect, embodiments of this application provide a LiDAR detection method, including:
obtaining point cloud data corresponding to an i−1^{th} ground line and point cloud data corresponding to an i−2^{th} ground line, i is an integer greater than or equal to 3;
calculating a predicted height range of an i^{th} ground line, based on the point cloud data corresponding to the i−1^{th} ground line and the point cloud data corresponding to the i−2^{th} ground line;
determining a target point in scanning points, by detecting a scanning point of an i^{th} row of a scanning line based on the predicted height range; and
obtaining the i^{th} ground line based on the target point, wherein distances between the i−2^{th} ground line, the i−1^{th} ground line, the i^{th} ground line, and the LiDAR are in order from nearest to far.

In a second aspect, embodiments of this application provide a LiDAR detection device, including:
a data obtaining module, configured to obtain point cloud data corresponding to an i−1^{th} ground line and point cloud data corresponding to an i−2^{th} ground line, i is an integer greater than or equal to 3;
a height calculation module, configured to calculate a predicted height range of the i^{th} ground line based on the point cloud data corresponding to the i−1^{th} ground line and the point cloud data corresponding to the i−2^{th} ground line;
a data detection module, configured to determine a target point in scanning points, by detecting a scanning point of an i^{th} row of a scanning line based on the predicted height range;
a data generation module, configured to obtain the i^{th} ground line based on the target points; the distances between the i−2^{th} ground line, the i−1^{th} ground line, the i^{th} ground line, and the LiDAR are in order from nearest to far.

In a third aspect, embodiments of this application provide a computer storage medium, which stores multiple instructions suitable for being loaded and executed by a processor to perform the method steps.

In a fourth aspect, embodiments of this application provide an electronic device, which may include: a memory and a processor; where the memory stores a computer program, and the computer program is suitable for being loaded and executed by the memory to perform the method steps.

In an embodiment of the application, point cloud data corresponding to the i−1^{th} ground line and point cloud data corresponding to the i−2^{th} ground line are obtained. Based on the point cloud data corresponding to the i−1^{th} ground line and the point cloud data corresponding to the i−2^{th} ground line, the predicted height range of the i^{th} ground line is calculated. The scanning points on the i^{th} row of the scanning line are detected based on the predicted height range, to determine target points in the scanning points, and the i^{th} ground line is obtained based on the target points. The distances between the i−2^{th} ground line, the i−1^{th} ground line, the i^{th} ground line, and the LiDAR are in order from nearest to far. Using the point cloud data corresponding to the relatively close i−1^{th} ground line and the point cloud data corresponding to the i−2^{th} ground line, reliable ground points on the i^{th} row of the scanning line are selected, to obtain the i^{th} ground line based on the fitted heights of the reliable ground points, thereby improving the clarity of the i^{th} ground line and enhancing the stability of the i^{th} ground line.

### BRIEF DESCRIPTION OF DRAWINGS

To explain the technical solutions in the embodiments of the present application more clearly, the following briefly describes the drawings required for the description of the embodiments.

FIG. 1 is a schematic diagram of a LiDAR detection method, according to some embodiments;

FIG. 2 is a flowchart of a LiDAR detection method, according to some embodiments;

FIG. 3 is a flowchart of another LiDAR detection method, according to some embodiments;

FIG. 4 is a flowchart of another LiDAR detection method, according to some embodiments;

FIG. 5 is a schematic structural diagram of a LiDAR detection device, according to some embodiments; and

FIG. 6 is a schematic structural diagram of a LiDAR, according to some embodiments.

### DETAILED DESCRIPTION

In the description of this application, the terms “first,” “second,” etc., are used for descriptive purposes only and should not be understood as indicating or implying relative importance. Unless otherwise explicitly defined and limited, the terms “include” and “have” and their variations are intended to cover non-exclusive inclusions. For example, a process, method, system, product, or device that comprises a series of steps or elements is not limited to the listed steps or elements, but includes steps or elements not listed, or includes other steps or elements inherent to the process, method, product, or device. The term “multiple” means two or more. The use of “and/or” describes the association relationship of associated objects, indicating three relationships. For example, A and/or B may indicate: existing A alone, existing A and B simultaneously, or existing B alone. The character “/” generally indicates an “or” relationship between associated objects before and after it.

In the field of LiDAR, the intensity of the reflected signal corresponding to a target scanned by the LiDAR is related to the incidence angle of the laser to the target. The larger the incidence angle, the weaker the reflected signal intensity. The LiDAR is installed approximately parallel to the ground. The farther the ground is from the LiDAR, the greater the incidence angle of the incident laser to that part of the ground. Thus, the attenuation of the light signal increases, and the signal-to-noise ratio of the ground reflected signal deteriorates, leading to issues such as point cloud data loss or inaccurate ranging results. When recognizing ground information from the point cloud of the LiDAR, the obtained ground line is fuzzy with poor clarity. Therefore, improving the clarity of the ground line detected by the LiDAR is an urgent technical problem that needs to be solved.

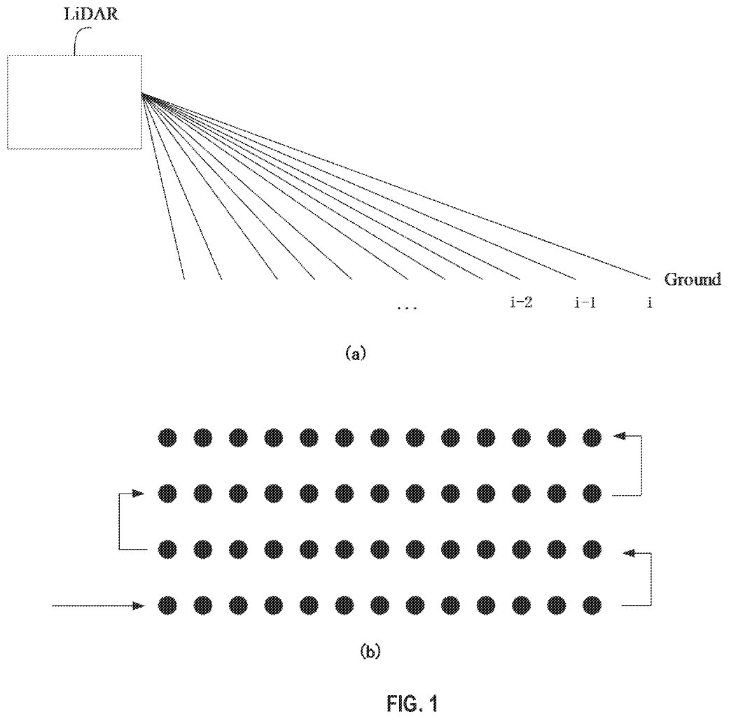

FIG. 1 is a schematic diagram of a LiDAR detection method provided in an embodiment.

As shown in FIG. 1, FIG. 1(a) illustrates a schematic diagram of the beam distribution of a Micro Electromechanical System (MEMS) LiDAR; FIG. 1(b) shows a scanning trajectory output by a MEMS LiDAR.

In FIG. 1(a), the relative positions of the i^{th} ground line, the i−1^{th} ground line, and the i−2^{th} ground line on the ground are shown. The distances between the LiDAR and the i−2^{th} ground line, the i−1^{th} ground line, and the i^{th} ground line are in order from nearest to far, i is an integer greater than or equal to 3. The farther the ground line is from the LiDAR, the larger the incidence angle of the corresponding incident laser, and the less clear the detected ground line, for example, with severe defects and indistinguishable ground boundaries.

In an embodiment, the detection method store one frame of point cloud data obtained by a LiDAR scanning the entire field of view in a buffered manner, from which the nearest first and second ground lines to the LiDAR can be identified, serving as a basis for detecting more distant scanning lines row by row. Storing one frame of point cloud data in a buffered manner consumes more storage resources. The detection method of an embodiment is used for LiDAR that scans row by row, such as MEMS LiDAR. FIG. 1(b) shows the scanning points on the i^{th} row of the scanning line, the scanning points on the i−1^{th} row of the scanning line, the scanning points on the i−2^{th} row of the scanning line, and the scanning points on the i−3^{th} row of the scanning line. The first row of scanning points from top to bottom in FIG. 1(b) represent the scanning points on the i^{th} row of the scanning line. The second row of scanning points in FIG. 1(b) represent the scanning points on the i−1^{th} row of the scanning line. The third row of scanning points in FIG. 1(b) represent the scanning points on the i−2^{th} row of the scanning line. The first row of scanning points in FIG. 1(b) represent the scanning points on the i−3^{th} row of the scanning line. The direction of the arrows in FIG. 1(b) indicates the scanning sequence of these scanning points. The incident laser of the LiDAR is deflected by the scanning device and projected into the field of view, scanning the field of view according to the scanning sequence, such as from the lower left as the starting position, scanning row by row from bottom to top as shown in FIG. 1(b). MEMS LiDAR scans row by row from bottom to top, the point cloud data of the previous two rows of scanning lines to detect the current row's ground line, thus consuming fewer storage resources. MEMS LiDAR that scans row by row from top to bottom can use the detection method, which requires storing one frame of point cloud data before detection.

In an embodiment, i is 3. The i−2^{th} ground line is obtained by radar based on the ground points on the i−2^{th} scan line identified by the algorithm. The i−1^{th} ground line is obtained by radar based on the ground points on the i−1^{th} scan line identified by the algorithm. Since the scanning points on the first and second rows of the scanning line are relatively close to the LiDAR, the quality of the received echo signals is good, and accurate detection results of the scanning points are obtained through sampling and calculation, accurately identifying the ground line points from the detection results of the entire row of scanning points. The i^{th} ground line uses the point cloud data corresponding to the i−2^{th} ground line and the point cloud data corresponding to the i−1^{th} ground line to perform a series of calculations, selecting the target point from the scanning points on the i^{th} row of the scanning line based on the target point to obtain the i^{th} ground line.

In an embodiment, obtains the point cloud data corresponding to the i−1^{th} ground line and the point cloud data corresponding to the i−2^{th} ground line, based on the point cloud data corresponding to the i−1^{th} ground line and the point cloud data corresponding to the i−2^{th} ground line, calculates the predicted height range of the i^{th} ground line, detects the scanning points of the i^{th} row of the scanning line based on the predicted height range, determines the target point in the scanning points, and obtains the i^{th} ground line based on the target point, where the distances between the i−2^{th} ground line, the i−1^{th} ground line, the i^{th} ground line, and the LiDAR are in order from nearest to far. Selects the ground points on the i^{th} scanning line with higher reliability by using the point cloud data of the i−1^{th} ground line and the point cloud data of the i−2^{th} ground line, which are closer to the LiDAR, to generate the i^{th} ground line based on the fitted height of the more reliable ground points, thereby improving the clarity of the i^{th} ground line and enhancing its stability.

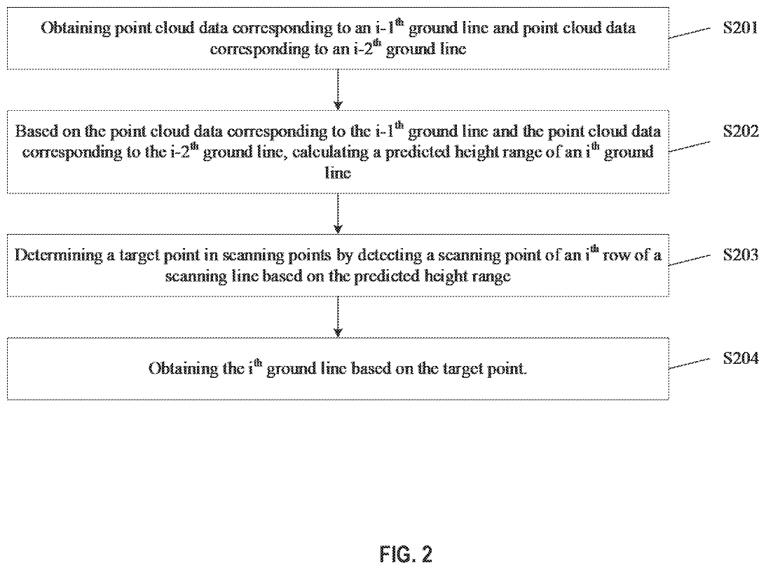

FIG. 2 is a flowchart of a LiDAR detection method provided in an embodiment. As shown in FIG. 2, the method includes the following steps.

S201, obtaining point cloud data corresponding to an i−1^{th} ground line and point cloud data corresponding to an i−2^{th} ground line, i is an integer greater than or equal to 3.

The i−1^{th} ground line refers to the ground line adjacent to the i^{th} ground line and closer to the LiDAR than the i^{th} ground line. The distance between the i−1^{th} ground line and the LiDAR is smaller than the distance between the i^{th} ground line and the LiDAR.

The point cloud data corresponding to the i−1^{th} ground line refers to the detection results of multiple scanning points corresponding to the i−1^{th} ground line. Scanning points are the points obtained by the LiDAR after each emission of incident laser and reception of corresponding echo laser. The LiDAR continuously scans the field of view to obtain a series of scanning points arranged in the scanning order. The detection results of the scanning points include the coordinates of the scanning points in the coordinate system with the LiDAR as the origin, the height of the scanning points, the yaw angle of the scanning points, the pitch angle of the scanning points, the relative speed of the scanning points, and the distance of the scanning points relative to the origin. All scanning points obtained by the LiDAR completing a scan of the field of view constitute a frame of point cloud data.

In a three-dimensional coordinate system with the LiDAR as the center O, the direction facing the LiDAR is the positive direction of the x-axis, the vertical upward direction is the z-axis, and the direction perpendicular to the xoz plane is the y-axis direction. The yaw angle refers to the angle between the light and the xoz plane, and the pitch angle refers to the angle between the light and the xoy plane.

The i−2^{th} ground line refers to the ground line adjacent to the i−1^{th} ground line and closer to the LiDAR than the i−1^{th} ground line. The distance between the i−2^{th} ground line and the LiDAR is smaller than the distance between the i−1^{th} ground line and the LiDAR.

The point cloud data corresponding to the i−2^{th} ground line refers to the detection results of multiple scanning points corresponding to the i−2^{th} ground line. The scanning points here refer to the scanning points used to obtain the i−2^{th} ground line. The detection results include the coordinates of the scanning points in the three-dimensional coordinate system with the LiDAR as the origin, the height of the scanning points, the yaw angle of the scanning points, the pitch angle of the scanning points, the relative speed of the scanning points, and the distance of the scanning points relative to the origin.

In some embodiments, the i−1^{th} ground line comprise some or all of the scanning points on the i−1^{th} row of the scanning line, and the i−2^{th} ground line comprise some or all of the scanning points on the i−2^{th} row of the scanning line. In an embodiment, i is equal to 3, the i−2^{th} ground line is the closest ground line to the LiDAR, and the i−1^{th} ground line is the ground line closest to the i−2^{th} ground line. The point cloud data of the scanning points constituting the i−2^{th} ground line, and the point cloud data of the scanning points constituting the i−1^{th} ground line are identified by algorithms. In an embodiment, multiple consecutive scanning points with unchanged height are identified by the algorithm, the reflectivity information of the scanning points are used to verify the scanning points. i is greater than 3, the i−2^{th} ground line and the i−1^{th} ground line are determined, the point cloud data of these scanning points are obtained from the previously stored data of the LiDAR.

S202, based on the point cloud data corresponding to the i−1^{th} ground line and the point cloud data corresponding to the i−2^{th} ground line, calculating a predicted height range of an i^{th} ground line.

In some embodiments, based on the point cloud data corresponding to the i−1^{th} ground line, the yaw angle and height of each scanning point on the i−1^{th} ground line are obtained. A m^{th} scanning point on the i−1^{th} ground line is denoted as S_{(i-1,m)}, where m is an integer greater than or equal to 1. Based on the point cloud data corresponding to the i−2^{th} ground line, the yaw angle and height of each scanning point on the i−2^{th} ground line are determined. The n^{th} scanning point on the i−2^{th} ground line is denoted as S_{(i-2,n)}, where n is an integer greater than or equal to 1. The scanning points on the i−1^{th} ground line and the scanning points on the i−2^{th} ground line can be traversed to obtain K pairs of points, where K is a positive integer. A pair of points include a corresponding first reference point and a second reference point. The first reference point is a scanning point on the i−1^{th} ground line, and the second reference point is a scanning point on the i−2^{th} ground line. Each pair of points comprises a unique first reference point and a unique second reference point. In each pair of points, the yaw angles of the first reference point and the second reference point are the same. The criterion for determining that the yaw angles of the first reference point and the second reference point are the same is that the absolute value of the difference in yaw angles between the first reference point and the second reference point is less than or equal to a threshold. Calculating the predicted height range of the i^{th} ground line means calculating the predicted height range of the ground points on the i^{th} ground line. For the scanning points on the i^{th} ground line, a scanning point with the same yaw angle as a certain pair of points. A predicted height range of this scanning point is calculated based on the heights of the first reference point and the second reference point constituting the pair of points. For scanning points on the i^{th} ground line with no yaw angle identical to that of any pair of points, a predicted height range of this scanning point is calculated based on the predicted height range of the scanning points adjacent to it and having the same yaw angle as a certain pair of points.

S203, determining a target point in the scanning points, by detecting a scanning point of an i^{th} row of a scanning line based on the predicted height range.

The i^{th} row of the scanning line refers to the i^{th} row of the scanning line in a frame of point cloud data. When the scanning sequence of the LiDAR is row by row from bottom to top, in a frame of point cloud data, the i^{th} row of the scanning line is located above the i−1^{th} row of the scanning line, and the i−1^{th} row of the scanning line is located above the i−2^{th} row of the scanning line.

In some embodiments, each scanning point on the i^{th} row of the scanning line is detected based on the predicted height range of each scanning point to determine whether this scanning point is a ground point. If a certain scanning point is determined to be a ground point, this scanning point is determined as a target point.

In an embodiment, based on the predicted height range of each scanning point, each scanning point can be detected to determine whether it is a ground point. In an embodiment, denoting scanning points on the i^{th} ground line as Si,j, where j is a positive integer and less than or equal to the total number of scanning points on the i^{th} row of the scanning line. The heights of multiple scanning points in the neighborhood window with the scanning point Si,j as the center can be obtained and compared with the predicted height range of the scanning point Si,j, to determine whether the scanning point Si,j is a ground point.

If the preset length of the neighborhood window is 10, the detection window can contain 10 consecutive scanning points, where the 6^{th} scanning point is the scanning point Si,j.

Comparing the heights of multiple scanning points in the neighborhood window with the predicted height range of the scanning point Si,j, to determine whether the scanning point Si,j is a ground point can be understood as follows: if the predicted height range of the scanning point Si,j is the first height range, it is determined that the scanning point Si,j is a ground point if the number of scanning points in the neighborhood window whose heights fall within the first height range reaches a preset number and the height of the scanning point Si,j is within the first height range.

S204, obtaining the i^{th} ground line based on the target point.

In an embodiment, the target point is denoted as Si,q, where q is a positive integer and less than or equal to the total number of target points on the i^{th} row of the scanning line. The target point Si,q is fitted to obtain the fitted height, and the i^{th} ground line is obtained based on the fitted height. The i^{th} ground line is obtained by connecting the target points Si,q based on their fitted heights.

In an embodiment, the point cloud data corresponding to the i−1^{th} ground line and the point cloud data corresponding to the i−2^{th} ground line are obtained. Based on the point cloud data corresponding to the i−1^{th} ground line and the point cloud data corresponding to the i−2^{th} ground line, the predicted height range of the i^{th} ground line is calculated. Based on the predicted height range, the scanning points of the i^{th} row of the scanning line are detected, the target points in the scanning points are determined, and the i^{th} ground line is obtained based on the target points. The distances between the i−2^{th} ground line, the i−1^{th} ground line, the i^{th} ground line, and the LiDAR are in order from nearest to far. Since the incident angle of the incident laser closer to the LiDAR is relatively large, the quality of the received echo signals is good, and accurate detection results of the scanning points are obtained through sampling and calculation, identifying the ground line points from the detection results of the entire row of scanning points. Selects the target points from the scanning points on the i^{th} row of the scanning line by using the point cloud data of the i−1^{th} ground line and the point cloud data of the i−2^{th} ground line, which are closer to the LiDAR, and fits these target points to obtain their fitted heights, based on which the i^{th} ground line is obtained. The clarity of the i^{th} ground line is improved, and the stability of the i^{th} ground line is enhanced. The point cloud data of the i−1^{th} ground line and the point cloud data of the i^{th} ground line enhanced by the above method are used to calculate the predicted height range of the i+1^{th} ground line and detect the scanning points of the i+1^{th} row of the scanning line. This process is repeated to detect and enhance the ground lines in a frame of point cloud data. The clarity of the ground line is improved and the clarity of the originally less clear distant ground line is also increased, thereby extending the maximum distance at which stable ground lines are detected.

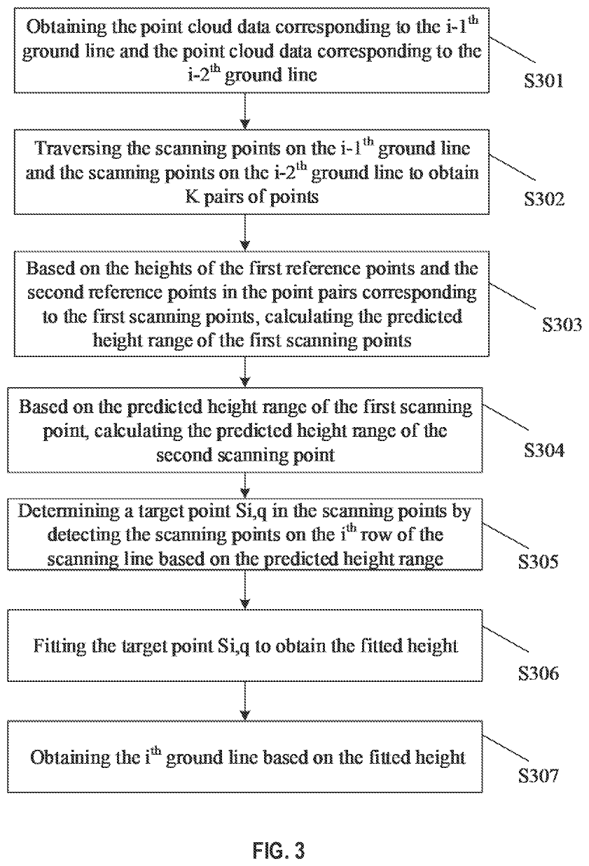

FIG. 3 is a flowchart of another LiDAR detection method provided in an embodiment.

As shown in FIG. 3, the method includes the following steps.

S301, obtaining the point cloud data corresponding to the i−1^{th} ground line and the point cloud data corresponding to the i−2^{th} ground line.

In an embodiment, this process refers to the description of S201 in the embodiment shown in FIG. 2.

S302, traversing the scanning points on the i−1^{th} ground line and the scanning points on the i−2^{th} ground line to obtain K pairs of points, where K is a positive integer.

A pair of points includes a corresponding first reference point and a second reference point. The first reference point is a scanning point on the i−1^{th} ground line, and the second reference point is a scanning point on the i−2^{th} ground line. The absolute value of the difference in yaw angles between the first reference point and the second reference point is less than or equal to a threshold.

In an embodiment, scanning points corresponding to the i−2^{th} ground line and scanning points corresponding to the i−1^{th} ground line are traversed to find K pairs of points with the same yaw angle. Each pair of points comprises a first reference point from the i−1^{th} ground line and a second reference point from the i−2^{th} ground line. The same yaw angle means that the absolute value of the difference in yaw angles between the first reference point and the second reference point is less than or equal to a threshold. In an embodiment, the process of finding K pairs of points comprises: determining a first yaw angle corresponding to all scanning points on the i−2^{th} ground line, determining a second yaw angle corresponding to all scanning points on the i−1^{th} ground line; for each first yaw angle, checking whether there is a second yaw angle with the same yaw angle; if there is a second yaw angle with the same yaw angle, the scanning points corresponding to the first yaw angle and the scanning points corresponding to the second yaw angle are considered as a pair of points. Multiple pairs of points are determined. The scanning points from the i−1^{th} ground line in each pair of points are the first reference point, and the scanning points from the i−2^{th} ground line are the second reference point.

S303, based on the heights of the first reference points and the second reference points in the point pairs corresponding to the first scanning points, calculating the predicted height range of the first scanning points.

The scanning points on the i^{th} row of the scanning line, where the difference in yaw angles between them and the scanning points in the K pairs of points is less than or equal to the threshold, are the first scanning points, while the remaining scanning points are the second scanning points.

The first scanning points are selected from all the scanning points on the i^{th} row of the scanning line. Each first scanning point is selected based on different pairs of points.

The height fluctuation values of the K first reference points in the K pairs of points and the gradient values of the point pairs corresponding to the first scanning points are obtained. Based on the height fluctuation values and gradient values, the predicted height range of the first scanning points is calculated.

The height fluctuation values are calculated from the heights of the K first reference points in the K pairs of points. In an embodiment, the calculation formula for the height fluctuation value is:

$$Δ h = \sqrt{\frac{{\sum }_{k = 1}^{K} ( {h}_{i - 1 , k} - \overline{h} )}{K}}$$

$$\overline{h} = \frac{{\sum }_{k = 1}^{K} {h}_{i - 1 , k}}{K}$$

k represents a summation parameter, with values ranging from 1 to K. K represents the total number of first reference points, i.e., the total number of pairs of points. h_{i-1,k} represents the height of the first reference point in the k^{th} pair of points corresponding to the first scanning point.

For the k^{th} pair of points corresponding to the first scanning point, the height of the first reference point and the height of the second reference point in the k^{th} pair of points are used to calculate a gradient value. In an embodiment, a calculation formula for the gradient value is:

$${G}_{k} = \frac{( {h}_{i - 1 , k} - {h}_{i - 2 , k} )}{\sqrt{{( {x}_{i - 1 , k} - {x}_{i - 2 , k} )}^{2} + {( {y}_{i - 1 , k} - {y}_{i - 2 , k} )}^{2}}} ,$$

where h_{i-2,k} represents the height of the second reference point in the k^{th} pair of points corresponding to the first scanning point; x_{i-1,k} and y_{i-1,k} represent the x-axis and y-axis coordinate values, respectively, of the first reference point in the k^{th} pair of points corresponding to the first scanning point in the three-dimensional coordinate system with the LiDAR as the center; x_{i-2,k} and y_{i-2,k} respectively represent the x-axis and y-axis coordinate values of the second reference point in the k^{th} pair of points corresponding to the first scanning point in the three-dimensional coordinate system with the LiDAR as the center.

Based on the height fluctuation value and the gradient value, the predicted height range of the first scanning point is calculated. In an embodiment, based on the K pairs of points, select the first scanning point with the same yaw angle as each pair of points from the scanning points on the i^{th} row of the scanning line; and based on the height fluctuation value of the first reference point and the gradient value of each pair of points, calculate the predicted height range of the first scanning point with the same yaw angle as the pair of points.

In an embodiment, for each pair of points, check whether there is a scanning point with the same yaw angle in the scanning points on the i^{th} row of the scanning line. If such a scanning point exists, select it as the first scanning point corresponding to the pair of points. The criterion for the same yaw angle is that the absolute value of the difference in yaw angles between the scanning point and the first reference point in the pair of points is less than or equal to a threshold, or the absolute value of the difference in yaw angles between the scanning point and the second reference point in the pair of points is less than or equal to the threshold.

For some pairs of points, there may be no matching first scanning point found in the i^{th} row of the scanning line. In an embodiment, the matching point for a certain pair of points might have been lost, so there is no matching first scanning point for it, the number of first scanning points may be less than the number of pairs of points K.

In an embodiment, based on the height fluctuation value of the first reference point and the gradient value of each pair of points, calculate the maximum height and the minimum height of the first scanning point with the same yaw angle as the pair of points. The minimum height and maximum height together form the predicted height range of the first scanning point.

In an embodiment, a formula for calculating the maximum height is:

$$max {h}_{k} = {h}_{i - 1 , k} \cdot [ 1 + \frac{( tan {p}_{i - 1 , k} - tan {p}_{i , k} )}{tan {p}_{i - 1 , k} \cdot tan {p}_{i , k}} \cdot \frac{{G}_{k} \cdot tan {p}_{i , k}}{tan {p}_{i , k} - {G}_{k}} ] + B \cdot Δ h ,$$

where p_{i-1,k} represents the pitch angle of the first reference point in the k^{th} pair of points corresponding to the first scanning point, p_{i,k} represents the pitch angle of the first scanning point with the same pitch angle as the first reference point in the k^{th} pair of points corresponding to the first scanning point; B represents a first preset parameter; Gₖ represents the gradient value of each pair of points; and Δh represents the height fluctuation value of the first reference point in each pair of points.

In an embodiment, a formula for calculating the minimum height is:

$$min {h}_{k} = {h}_{i - 1 , k} \cdot [ 1 + \frac{( tan {p}_{i - 1 , k} - tan {p}_{i , k} )}{tan {p}_{i - 1 , k} \cdot tan {p}_{i , k}} \cdot \frac{{G}_{k} \cdot tan {p}_{i , k}}{tan {p}_{i k} - {G}_{k}} ] - A \cdot Δ h ,$$

where p_{i-1,k} represents the pitch angle of the first reference point in the k^{th} pair of points corresponding to the first scanning point, and p_{i,k} represents the pitch angle of the first scanning point with the same pitch angle as the first reference point in the k^{th} pair of points corresponding to the first scanning point; A represents a second preset parameter; Gₖ represents the gradient value of each pair of points; and Δh represents the height fluctuation value of the first reference point in each pair of points.

S304, based on the predicted height range of the first scanning point, calculating the predicted height range of the second scanning point.

The first scanning point is a point with the same yaw angle as a certain pair of points. The first scanning point has a spatial correspondence with the scanning points in the corresponding pair of points, such as being located on the same xoz plane. Due to the continuity of the ground, the likelihood that the first scanning point is a ground point is high. Therefore, the predicted height range of the first scanning point can be calculated accurately based on the gradient value and the height fluctuation value of the first reference point.

Apart from the first scanning points with the same yaw angle as the pairs of points, there are scanning points on the i^{th} row of the scanning line that do not match the pairs of points (the second scanning points).

In an embodiment, the second scanning points do not match the pairs of points. Their predicted height range are not calculated based on the heights of the scanning points in the pairs. The predicted height range of the second scanning points is determined using the adjacent first scanning points.

In an embodiment, at least two first scanning points adjacent to the second scanning point on the i^{th} row of the scanning line are identified, and the predicted height range of the second scanning point are calculated based on the predicted height ranges of the at least two first scanning points.

In an embodiment, for each second scanning point, a linear fitting method or a cubic spline fitting method is used to calculate the predicted height range of the second scanning point based on the predicted height ranges of at least two first scanning points adjacent to it.

In an embodiment, a process of identifying at least two first scanning points adjacent to the second scanning point is disclosed. For example, a second scanning point is the m^{th} point on the i^{th} row of the scanning line. A scanning point adjacent to the m^{th} point and located before the m^{th} point is determined to be a first scanning point, and another scanning point adjacent to the m^{th} point and located after the m^{th} point is determined to be a first scanning point, these two first scanning points are identified as the two first scanning points adjacent to the m^{th} point. If no first scanning points are found before and after the m^{th} point, the two first scanning points closest and next closest to the m^{th} point located before the m^{th} point, or the two first scanning points closest and next closest to the m^{th} point located after the m^{th} point, are identified as the two first scanning points adjacent to the m^{th} point.

In an embodiment, a method for determining the scanning points before and after the m^{th} point is referred to in the schematic diagram of the scanning sequence of the scanning points shown in FIG. 1(b). According to the scanning points shown in FIG. 1(b), the fourth row is the fourth row from top to bottom, and the m^{th} point is the 5^{th} scanning point from left to right in the fourth row, then the first 4 scanning points from left to right in the fourth row are the scanning points before the m^{th} point, and the first 8 scanning points from right to left in the fourth row are the scanning points after the m^{th} point. The third row is the third row from top to bottom, and the m^{th} point is the 5^{th} scanning point from left to right in the third row, then the first 8 scanning points from right to left in the third row are the scanning points before the m^{th} point, and the first 4 scanning points from left to right in the third row are the scanning points after the m^{th} point.

In an embodiment, the two first scanning points adjacent to the m^{th} point are denoted as the p^{th} point and the q^{th} point, respectively. A formula for calculating the minimum height of the m^{th} point is:

$$min h = \frac{min {h}_{p} - min {h}_{q}}{p - q} ( m - q ) + min {h}_{q} ,$$

where min hₚ represents the minimum height in the predicted height range of the p^{th} point, and min h_{q} represents the minimum height in the predicted height range of the q^{th} point.

In an embodiment, a formula for calculating the maximum height of the m^{th} point is:

$$max h = \frac{max {h}_{p} - max {h}_{q}}{p - q} ( m - q ) + max {h}_{q} ,$$

where max hₚ represents the maximum height in the predicted height range of the p^{th} point, and max h_{q} represents the maximum height in the predicted height range of the q^{th} point.

The height range comprises the minimum height and maximum height of the m^{th} point mentioned above is the predicted height range of the m^{th} point.

In an embodiment, the predicted height range of most second scanning points on the i^{th} row of the scanning line is calculated. In an embodiment, for a few second scanning points without at least two adjacent first scanning points nearby, their predicted height range is not calculated.

S305, determining a target point Si,q in the scanning points, by detecting the scanning points on the i^{th} row of the scanning line based on the predicted height range.

In an embodiment, A1: Obtain the heights of multiple scanning points in the neighborhood window centered on the scanning point Si,j. j is a positive integer and less than or equal to the total number of scanning points on the i^{th} row of the scanning line.

In an embodiment, a neighborhood window is constructed centered on the scanning point Si,j, and a preset number of adjacent scanning points near the scanning point Si,j are obtained. The multiple scanning points in the neighborhood window are scanning points on the i^{th} row of the scanning line. Their heights are obtained from the point cloud data detected by the LiDAR.

The adjacent scanning points near the scanning point Si,j include scanning points located before and after the scanning point Si,j. The scanning point Si,j is taken as the center of the neighborhood window, with a preset number of adjacent scanning points before and after the scanning point Si,j, forming the front and rear halves of the neighborhood window, respectively. In an embodiment, if the preset number is 5, the 5 adjacent scanning points before and after the scanning point Si,j are identified as the adjacent scanning points. Thus, the neighborhood window comprises the scanning point Si,j as the center, the 5 adjacent scanning points before it as the front half, and the 5 adjacent scanning points after it as the rear half.

A2: Compare the heights of the multiple scanning points in the neighborhood window with the predicted height range of the scanning point Si,j, to determine whether the scanning point Si,j is a ground point.

In an embodiment, a ground point refers to a scanning point whose coordinates represent a point on the ground.

In an embodiment, determining the scanning point Si,j as a ground point is: when the height of the scanning point Si,j is within its predicted height range, and the number of scanning points in the neighborhood window whose heights are within the predicted height range of the scanning point Si,j is greater than a first threshold, the scanning point is determined to be a ground point. When the height of the scanning point Si,j is within its predicted height range, and the number of scanning points in the neighborhood window whose heights are within the predicted height range of the scanning point Si,j is greater than the first threshold, the scanning point is determined as a ground point. The scanning points in the neighborhood window refer to the scanning points within the neighborhood window corresponding to the scanning point Si,j. The first threshold is an integer threshold, such as 3.

When the height of the scanning point Si,j is within its predicted height range, it indicates a high likelihood that the scanning point Si,j is a ground point. The heights of the scanning points surrounding Si,j (the multiple scanning points in the neighborhood window centered on Si,j) are checked to ensure accurate determination.

In an embodiment, a neighborhood window includes the following scanning points: d, e, f, g, h, i, j, k, l, m, n. The center of this neighborhood window is point i, which is the scanning point Si,j, and the remaining points are the scanning points within the neighborhood window corresponding to point i. When the height of point i is within its predicted height range, the heights of points g, h, and j are within the predicted height range of point i, but the heights of the remaining points are not, the number of scanning points in the neighborhood window whose heights are within the predicted height range of point i is 3, then point i is determined to be a ground point. Otherwise, point i is not a ground point.

In an embodiment, determining the scanning point Si,j as a ground point comprises: when the height of the scanning point Si,j is not within its predicted height range, and the number of scanning points in the neighborhood window whose heights are within the predicted height range of the scanning point Si,j is greater than a second threshold, the scanning point is determined to be a ground point. When the height of the scanning point Si,j is not within its predicted height range, and the number of scanning points in the neighborhood window whose heights are within the predicted height range of the scanning point Si,j is greater than the second threshold, then the scanning point Si,j is determined as a ground point. The scanning points in the neighborhood window refer to the scanning points within the neighborhood window corresponding to the scanning point Si,j. In an embodiment, the second threshold is an integer threshold, such as 8.

When the height of the scanning point Si,j is not within its predicted height range, it indicates a low likelihood that the scanning point Si,j is a ground point. To avoid misjudgment, the heights of the scanning points surrounding Si,j (the multiple scanning points in the neighborhood window centered on Si,j) are checked. If the majority of these points' heights are within the predicted height range of the scanning point Si,j, then the initial conclusion that the scanning point Si,j is unlikely to be a ground point is incorrect, and it can be accurately determined that the scanning point Si,j is indeed a ground point.

In an embodiment, a neighborhood window includes the following scanning points: d, e, f, g, h, i, j, k, l, m, n. The center of this neighborhood window is point i, which is the scanning point Si,j, and the remaining points are the scanning points within the neighborhood window corresponding to point i. If the height of point i is not within its predicted height range, but the heights of points e, f, g, h, j, k, l, and n are within the predicted height range of point i, the number of scanning points in the neighborhood window whose heights are within the predicted height range of point i is 8, then point i can be determined to be a ground point. Otherwise, point i is not a ground point.

A3: If the scanning point is a ground point, it is determined as a target point.

In an embodiment, when a scanning point is determined to be a ground point, it can be identified as the target point used to obtain the i^{th} ground line.

S306, fitting the target point Si,q to obtain the fitted height.

The target point is denoted as Si,q, q is a positive integer and less than or equal to the total number of target points on the i^{th} row of the scanning line.

In an embodiment, the heights of multiple target points in the neighborhood window centered on the target point Si,q, or the heights of multiple target points in the neighborhood window where the target point Si,q is located, are obtained; a linear fitting based on the heights of the multiple target points in the neighborhood window is performed to obtain the fitted height of the target point.

In an embodiment, an implementation of obtaining the heights of multiple target points in the neighborhood window centered on the target point Si,q is: centered on the target point Si,q, obtaining a preset number of adjacent target points near the target point Si,q, and forming a neighborhood window centered on the target point Si,q with the adjacent target points. The heights of the multiple target points in the neighborhood window are obtained according to an algorithm of the LiDAR.

In an embodiment, an implementation of obtaining the heights of multiple target points in the neighborhood window where the target point Si,q is located is: identifying all target points before and after the target point Si,q, forming a neighborhood window with all these target points, and obtaining the fitted heights of these target points.

In an embodiment, an implementation of performing linear fitting based on the heights of multiple target points in the neighborhood window to obtain the fitted height of the target point Si,q is: using a least squares method to perform linear fitting on the height of the target point Si,q. According to the order of the target points Si,q on the i^{th} row of the scanning line, the target points in the neighborhood window can be stored in a sequence. The sequence number of the target point Si,q in a sequence is used as the independent variable, and the height of the target point Si,q is used as the dependent variable to find the linear function relationship between the independent variable and the dependent variable. The function value corresponding to the independent variable (the dependent variable value) can be used as the fitted height of the corresponding target point Si,q.

By performing linear fitting on the original height of the target point to obtain the fitted height, the effect of smoothing and de-noising the height of the target point is achieved.

S307, obtaining the i^{th} ground line based on the fitted height.

In an embodiment, connecting these target points Si,q based on their fitted heights yield the i^{th} ground line.

In an embodiment, by using pairs of points with the same yaw angle which comprises scanning points on the i−1^{th} ground line and scanning points on the i−2^{th} ground line, the predicted height range of the scanning points on the i^{th} row of the scanning line with the same yaw angle as the pair of points are calculated, and the predicted height range of the scanning points on the i^{th} row of the scanning line that do not match the pairs of points are calculated based on the predicted height range of the scanning points on the i^{th} row with the same yaw angle as the pairs of points. Based on the predicted height ranges of all scanning points, the ground points with higher reliability are selected from these scanning points. By fitting the heights of the ground points with higher reliability to obtain the fitted height, the i^{th} ground line is obtained. The clarity of the i^{th} ground line obtained from the ground points with higher reliability is improved, enhances the stability of the i^{th} ground line obtained from the smoothed and de-noised heights.

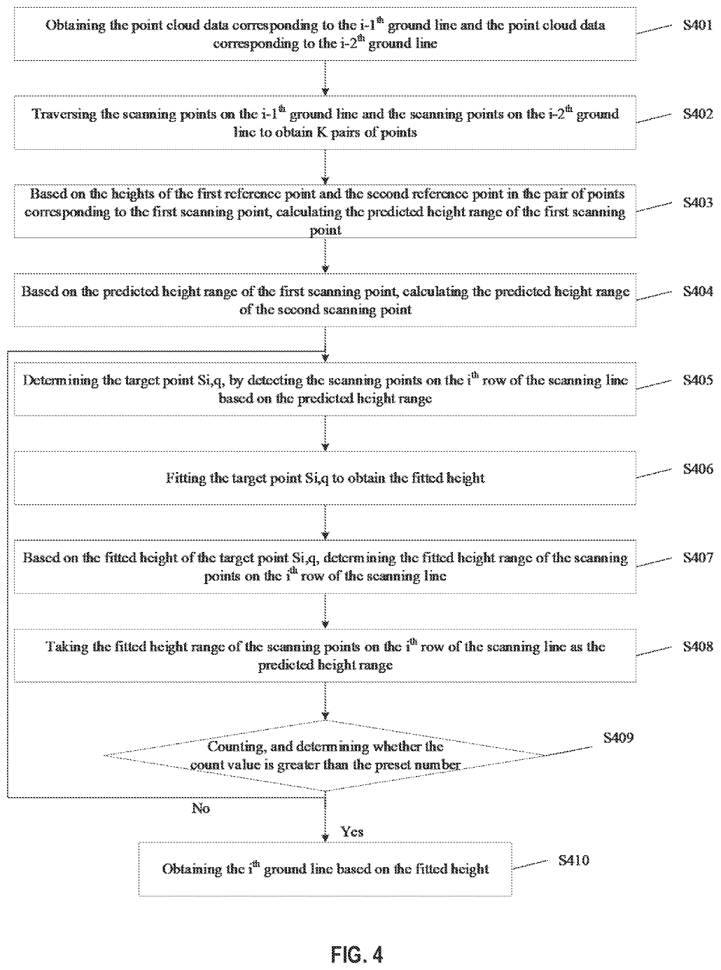

FIG. 4 is a flowchart of another LiDAR detection method provided in an embodiment. As shown in FIG. 4, the method includes the following steps.

S401, obtaining the point cloud data corresponding to the i−1^{th} ground line and the point cloud data corresponding to the i−2^{th} ground line.

S402, traversing the scanning points on the i−1^{th} ground line and the scanning points on the i−2^{th} ground line to obtain K pairs of points.

S403, based on the heights of the first reference point and the second reference point in the pair of points corresponding to the first scanning point, calculating the predicted height range of the first scanning point.

S404, based on the predicted height range of the first scanning point, calculating the predicted height range of the second scanning point.

S405, determining the target point Si,q, by detecting the scanning points on the i^{th} row of the scanning line based on the predicted height range.

S406, fitting the target point Si,q to obtain the fitted height.

In an embodiment, S401-S406 can refer to the description of S301-S306 in the embodiment shown in FIG. 3.

S407, based on the fitted height of the target point Si,q, determining the fitted height range of the scanning points on the i^{th} row of the scanning line.

The target points are the scanning points preliminarily judged to be ground points on the i^{th} row of the scanning line. Besides the target points, there are scanning points on the i^{th} row of the scanning line that are preliminarily judged not to be ground points (non-target points). The fitted height range of the target points are calculated based on the fitted heights of the target points. The fitted height range of the non-target points are calculated based on the fitted height range of the target points, thus obtaining the fitted height range of scanning points on the i^{th} row of the scanning line.

In an embodiment, an implementation of determining the fitted height range of the scanning points on the i^{th} row of the scanning line based on the fitted height of the target point Si,q is: obtaining the fitted heights of multiple target points in the neighborhood window centered on the target point Si,q, or obtaining the fitted heights of multiple target points in the neighborhood window where the target point Si,q is located; obtaining the fitted height fluctuation value based on the fitted heights of multiple target points in the neighborhood window; determining the fitted height range of the target point Si,q based on the fitted height and the fitted height fluctuation value of the target point Si,q, and determining the fitted height range of the non-target point Si,q based on the fitted height range of the target point Si,q.

The non-target points are the scanning points on the i^{th} row of the scanning line other than the target points, where p is a positive integer, q is a positive integer, the value of q ranges from 1 to Q, Q represents the total number of target points. The value of p ranges from 1 to P, P represents the total number of non-target points. The sum of Q and P is the total number of scanning points on the i^{th} row of the scanning line.

In an embodiment, an implementation of obtaining the fitted heights of multiple target points in the neighborhood window centered on the target point Si,q is: centered on the target point Si,q, obtaining a preset number of adjacent target points near the target point Si,q, forming a neighborhood window centered on the target point Si,q with the adjacent target points, and obtaining the fitted heights of these target points.

In an embodiment, an implementation of obtaining the fitted heights of multiple target points in the neighborhood window where the target point Si,q is located is: target points Si,q, target points before the target point Si,q, and target points after the target point Si,q are identified as the target points in the neighborhood window, and obtaining the fitted heights of these target points calculated as described above.

In an embodiment, an implementation of obtaining the fitted height fluctuation value based on the fitted heights of multiple target points in the neighborhood window, a calculation formula for the fitted height fluctuation value is:

$$Δ {{h}^{⌣}}_{i , j} = \sqrt{\frac{{\sum }_{q = 1}^{Q} {( {h}_{q} - {{h}^{⌣}}_{q} )}^{2}}{Q}} ,$$

where q represents the summation parameter, with values ranging from 1 to Q, and Q represents the total number of target points; h_{q} represents the height of the target point; ȟ^{q} represents the fitted height of the target point.

Based on the fitted height and the fitted height fluctuation value of the target point Si,q, the fitted height range of the target point Si,q is determined. In an embodiment, the maximum height and the minimum height in the fitted height range of the target point Si,q is determined based on the fitted height and the fitted height fluctuation value of the target point Si,q.

In an embodiment, a calculation formula for the maximum height in the fitted height range of the target point Si,q is:

$$max {h}_{i , j} = {{h}^{⌣}}_{i , j} + B \cdot Δ {{h}^{⌣}}_{i , j}$$

In an embodiment, a calculation formula for the minimum height in the fitted height range of the target point Si,q is:

$$min {h}_{i , j} = {{h}^{⌣}}_{i , j} - A \cdot Δ {{h}^{⌣}}_{i , j}$$

A and B are preset parameters.

By smoothing and de-noising the height of the target point to obtain the fitted height, the new predicted height range (the fitted height range) of the target point and the new predicted height range (the fitted height range) of the non-target point are estimated. This effectively re-estimates the predicted height range of the scanning points on the i^{th} row of the scanning line, achieving the effect of correcting the initially estimated predicted height range of the target points, thereby improving the accuracy of the predicted height range of the scanning points on the i^{th} row of the scanning line.

S408, taking the fitted height range of the scanning points on the i^{th} row of the scanning line as the predicted height range.

In an embodiment, for the scanning points on the i^{th} row of the scanning line, the fitted height range of the scanning points on the i^{th} row of the scanning line are calculated, the fitted height range of each scanning point is taken as the predicted height range of that scanning point.

S409, counting, and determining whether the count value is greater than the preset number.

In an embodiment, the count value is incremented by 1 and updated. The initial count value is 1, starting from 1, and each subsequent count is incremented by 1, the first count is 1, the second count is 2, the third count is 3, and so on. In an embodiment, the preset number is set to 3.

If the count value is greater than the preset number, execute S410: obtaining the i^{th} ground line based on the fitted height.

If the count value is not greater than the preset number, return to execute S405: detecting the scanning points on the i^{th} row of the scanning line based on the predicted height range, and determining the target point Si,q.

At this point, the predicted height range is the updated fitted height range after re-estimation. Therefore, based on the re-estimated height range, the target point Si,q in the scanning points is re-selected according to the implementation described in S405. S406 is re-executed to calculate the fitted height of the re-selected target point Si,q. S407, S408, and S409 are executed again, and then return to execute S405, S406, S407, S408, and S409 again. This achieves the purpose of iterative estimation of the height range and the iterative selection of the target point Si,q based on each estimated height range, and the iterative calculation of the fitted height of the target point Si,q, until the count value is greater than the preset number, at which point the iterative process stops, and S410 is executed: obtaining the ith ground line based on the fitted height.

S410 can be executed by connecting the target points' fitted heights calculated in the last iteration process to obtain the i^{th} ground line. Thus, the i^{th} ground line is a highly reliable ground line obtained through multiple iterative detections, thereby improving the clarity of the i^{th} ground line.

By iteratively detecting whether the target points are ground points, errors caused by the predicted height range of initially generated scanning points can be corrected, further enhancing the reliability of the finally detected ground points, and thereby improving the clarity of the i^{th} ground line.

By using pairs of points with the same yaw angle composed of scanning points on the i−1^{th} ground line and scanning points on the i−2^{th} ground line, the predicted height range of the scanning points on the i^{th} row of the scanning line with the same yaw angle as the pair of points are calculated, the predicted height range of the scanning points on the i^{th} row of the scanning line that do not match the pairs of points are calculated based on the predicted height range of the scanning points on the i^{th} row with the same yaw angle as the pairs of points. The highly reliable ground points can be selected from these scanning points by iteratively calculating the fitted height range of the scanning points on the i^{th} row of the scanning line. This improves the clarity of the i^{th} ground line obtained from the highly reliable ground points.

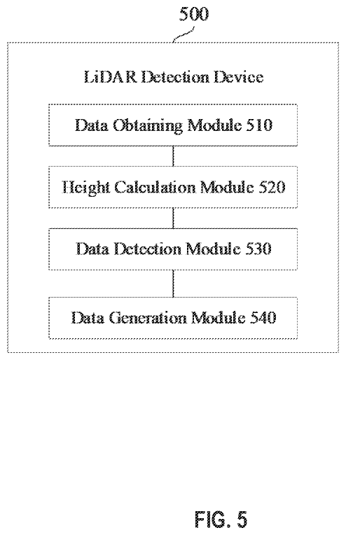

FIG. 5 is a schematic structural diagram of a LiDAR detection device provided in an embodiment.

Referring to FIG. 5, the LiDAR detection device 500 is implemented as all or part of the LiDAR through software, hardware, or a combination of both. The device 500 includes: a data obtaining module 510, configured to obtain the point cloud data corresponding to the i−1^{th} ground line and the point cloud data corresponding to the i−2^{th} ground line, i is an integer greater than or equal to 3; a height calculation module 520, configured to calculate the predicted height range of the i^{th} ground line based on the point cloud data corresponding to the i−1^{th} ground line and the point cloud data corresponding to the i−2^{th} ground line;
a data detection module 530, configured to detect the scanning points of the i^{th} row of the scanning line based on the predicted height range, to determine the target points in the scanning points; and
a data generation module 540, configured to obtain the i^{th} ground line based on the target points, where the distances between the i−2^{th} ground line, the i−1^{th} ground line, the i^{th} ground line, and the LiDAR are in order from nearest to far.

In an embodiment, the height calculation module includes: a first calculation unit, configured to traverse the scanning points on the i−1^{th} ground line and the scanning points on the i−2^{th} ground line to obtain K pairs of points, where a pair of points includes a corresponding first reference point and a second reference point. The first reference point is a scanning point on the i−1^{th} ground line, and the second reference point is a scanning point on the i−2^{th} ground line. The difference in yaw angles between the first reference point and the second reference point is less than or equal to the threshold; K is a positive integer; a second calculation unit, configured to calculate the predicted height range of the first scanning point based on the heights of the first reference point and the second reference point in the pair of points corresponding to the first scanning point; the scanning points on the i^{th} row of the scanning line with a yaw angle difference less than or equal to the threshold compared to the K pairs of points are the first scanning points, and the remaining scanning points with a yaw angle difference greater than the threshold compared to the K pairs of points are the second scanning points; and
a third calculation unit, configured to calculate the predicted height range of the second scanning points based on the predicted height range of the first scanning points.

In an embodiment, the second calculation unit includes: a first calculation subunit, configured to obtain the height fluctuation value of the K first reference points in the K pairs of points and the gradient value of the pair of points corresponding to the first scanning point; and
a second calculation subunit, configured to calculate the predicted height range of the first scanning point based on the height fluctuation value and the gradient value.

In an embodiment, the third calculation unit includes:
a third calculation subunit, configured to identify at least two first scanning points adjacent to the second scanning point on the i^{th} row of the scanning line; and
a fourth calculation subunit, configured to calculate the predicted height range of the second scanning point based on the predicted height ranges of at least two first scanning points adjacent to the second scanning point.

In an embodiment, the data detection module includes:
a first detection unit, configured to obtain the heights of multiple scanning points in the neighborhood window centered on the scanning point Si,j; where j is a positive integer and less than or equal to the total number of scanning points on the i^{th} row of the scanning line;
a second detection unit, configured to compare the heights of the multiple scanning points in the neighborhood window with the predicted height range of the scanning point Si,j to determine whether the scanning point Si,j is a ground point; and
a third detection unit, configured to determine the scanning point as a target point if it is a ground point.

In an embodiment, the second detection unit includes:
a first detection subunit, configured to determine the scanning point as a ground point when the height of the scanning point Si,j is within its predicted height range, and the number of scanning points in the neighborhood window whose heights are within the predicted height range of the scanning point Si,j is greater than the first threshold; and
a second detection subunit, configured to determine the scanning point as a ground point when the height of the scanning point Si,j is not within its predicted height range, and the number of scanning points in the neighborhood window whose heights are within the predicted height range of the scanning point Si,j is greater than the second threshold.

In an embodiment, the data generation module includes:
a first data generation unit, configured to fit the target point Si,q to obtain the fitted height; where q is a positive integer and less than or equal to the total number of target points on the i^{th} row of the scanning line; and
a second data generation unit, configured to obtain the i^{th} ground line based on the fitted height.

In an embodiment, the data generation module also includes:
a third data generation unit, configured to determine the fitted height range of the scanning points on the i^{th} row of the scanning line based on the fitted height of the target point Si,q; and
a fourth data generation unit, configured to take the fitted height range of the scanning points on the i^{th} row of the scanning line as the predicted height range and count, and return to execute the detection of the scanning points on the i^{th} row of the scanning line based on the predicted height range, to determine the target points in the scanning points, until the count value is greater than the preset number.

In an embodiment, the third data generation unit is configured to:
obtain the fitted heights of multiple target points in the neighborhood window centered on the target point Si,q;
obtain the fitted height fluctuation value based on the fitted heights of multiple target points in the neighborhood window;
determine the fitted height range of the target point Si,q based on the fitted height and the fitted height fluctuation value of the target point Si,q; and
determine the fitted height range of the non-target point Si,q based on the fitted height range of the target point Si,q; the non-target points are the scanning points on the i^{th} row of the scanning line other than the target points, p is a positive integer, and the sum of q and p is the total number of scanning points on the i^{th} row of the scanning line.

In an embodiment, the first data generation unit is configured to:
obtain the heights of multiple target points in the neighborhood window centered on the target point Si,q; and
perform linear fitting based on the heights of the multiple target points in the neighborhood window to obtain the fitted height of the target point Si,q.

In an embodiment, a LiDAR stores at least one instruction that, when loaded and executed by a processor, performs the method steps described in the embodiments shown in FIGS. 2-4. The execution process can be referred to the descriptions of the embodiments shown in FIGS. 2-4.

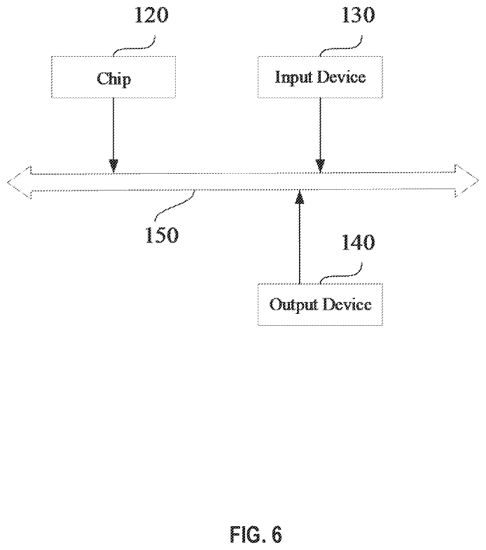

FIG. 6 is a schematic structural diagram of a LiDAR provided in an embodiment.

As shown in FIG. 6, the LiDAR includes one or more of the following components: chip 120, input device 130, output device 140, and bus 150. The chip 120, input device 130, and output device 140 are connected through the bus 150.

The chip 120 includes one or more processing cores. The chip 120 connects various parts of the LiDAR using various interfaces and routes and executes instructions, programs, code sets, or instruction sets stored in the chip 120 and calls data stored in the chip 120 to perform various functions and process data of terminal 100. The chip 120 can be implemented in at least one form of hardware such as digital signal processing (DSP), field-programmable gate array (FPGA), or programmable logic array (PLA). The chip 120 can integrate one or more combinations of central processing unit (CPU) and modems. The CPU primarily handles the operating system, user interface, and applications. It is understood that the modem may also be implemented separately from the chip 120 through a communication chip.

The chip 120 includes random access memory (RAM) and read-only memory (ROM). The chip 120 includes a non-transitory computer-readable storage medium. The chip 120 can store instructions, programs, codes, or code sets. The chip 120 can include a program storage area and a data storage area. The program storage area can store instructions for implementing the operating system, instructions for implementing at least one function (e.g., audio playback function), and instructions for implementing various method embodiments described below. The operating system can be the Android system, including systems deeply developed based on Android, Apple's IOS system, including systems deeply developed based on IOS, or other systems.

The input device 130 is used to receive input instructions or data and can include but is not limited to a keyboard, mouse, camera, microphone, or touch device. The output device 140 is used to output instructions or data and can include but is not limited to a display device and speakers. In one example, the input device 130 and the output device 140 can be integrated as a touch screen.

The touch screen can be designed as a full-screen, curved screen, or shaped screen. The touch screen can also be designed as a combination of a full-screen and a curved screen, or a shaped screen and a curved screen. The embodiments of this specification are not limited to this.

The LiDAR can include a radio frequency circuit, input unit, sensor, audio circuit, Wireless Fidelity (WiFi) module, power supply, Bluetooth module, etc.

In the LiDAR shown in FIG. 6, the chip 120 can process the program of the LiDAR detection method stored in the chip 120 and perform the following operations:
obtain point cloud data corresponding to the i−1^{th} ground line and point cloud data corresponding to the i−2^{th} ground line, i is an integer greater than or equal to 3;
calculate the predicted height range of the i^{th} ground line based on the point cloud data corresponding to the i−1^{th} ground line and the point cloud data corresponding to the i−2^{th} ground line;
determine a target point in the scanning points, by detecting the scanning points of the i^{th} row of the scanning line based on the predicted height range; and
obtain the i^{th} ground line based on the target points, wherein the distances between the i−2^{th} ground line, the i−1^{th} ground line, the i^{th} ground line, and the LiDAR are in order from nearest to far.

In an embodiment, the chip 120 performs the following operations when calculating the predicted height range of the i^{th} ground line based on the point cloud data corresponding to the i−1^{th} ground line and the point cloud data corresponding to the i−2^{th} ground line:
traverse the scanning points on the i−1^{th} ground line and the scanning points on the i−2^{th} ground line to obtain K pairs of points. A pair of points includes a corresponding first reference point and a second reference point. The first reference point is a scanning point on the i−1^{th} ground line, and the second reference point is a scanning point on the i−2^{th} ground line. The difference in yaw angles between the first reference point and the second reference point is less than or equal to the threshold, K is a positive integer;
calculate the predicted height range of the first scanning point based on the heights of the first reference point and the second reference point in the pair of points corresponding to the first scanning point. The scanning points on the i^{th} row of the scanning line with a yaw angle difference less than or equal to the threshold compared to the K pairs of points are the first scanning points, and the remaining scanning points with a yaw angle difference greater than the threshold compared to the K pairs of points are the second scanning points; and
calculate the predicted height range of the second scanning points based on the predicted height range of the first scanning points.

In an embodiment, the chip 120 performs the following operations when calculating the predicted height range of the first scanning point based on the heights of the first reference point and the second reference point in the pair of points corresponding to the first scanning point:
obtain the height fluctuation value of the K first reference points in the K pairs of points and the gradient value of the pair of points corresponding to the first scanning point; and
calculate the predicted height range of the first scanning point based on the height fluctuation value and the gradient value.

In an embodiment, the chip 120 performs the following operations when calculating the predicted height range of the second scanning point based on the predicted height range of the first scanning point:
identify at least two first scanning points adjacent to the second scanning point on the i^{t}h row of the scanning line; and
calculate the predicted height range of the second scanning point based on the predicted height ranges of at least two first scanning points adjacent to the second scanning point.

In an embodiment, the chip 120 performs the following operations when detecting the scanning points on the i^{th} row of the scanning line based on the predicted height range and determining the target points among the scanning points:
obtain the heights of multiple scanning points in the neighborhood window centered on the scanning point Si,j; where j is a positive integer and less than or equal to the total number of scanning points on the i^{th} row of the scanning line;
compare the heights of the multiple scanning points in the neighborhood window with the predicted height range of the scanning point Si,j to determine whether the scanning point Si,j is a ground point; and
if the scanning point is a ground point, determine the scanning point as a target point.

In an embodiment, the chip 120 performs the following operations when comparing the heights of the multiple scanning points in the neighborhood window with the predicted height range of the scanning point Si,j to determine whether the scanning point Si,j is a ground point:
determine the scanning point as a ground point when the height of the scanning point Si,j is within its predicted height range, and the number of scanning points in the neighborhood window whose heights are within the predicted height range of the scanning point Si,j is greater than the first threshold; and
determine the scanning point as a ground point when the height of the scanning point Si,j is not within its predicted height range, and the number of scanning points in the neighborhood window whose heights are within the predicted height range of the scanning point Si,j is greater than the second threshold.

In an embodiment, the chip 120 performs the following operations when obtaining the i^{t}h ground line based on the target points:
fit the target point Si,q to obtain the fitted height, where q is a positive integer and less than or equal to the total number of target points on the i^{th} row of the scanning line; and
obtain the i^{th} ground line based on the fitted height.

In an embodiment, after fitting the target point Si,q to obtain the fitted height corresponding to each target point, the chip 120 performs the following operations:
determine the fitted height range of the scanning points on the i^{th} row of the scanning line based on the fitted height of the target point Si,q; and
take the fitted height range of the scanning points on the i^{th} row of the scanning line as the predicted height range and count, and return to execute the detection of the scanning points on the i^{th} row of the scanning line based on the predicted height range, to determine the target points among the scanning points until the count value is greater than the preset number.

In an embodiment, the chip 120 performs the following operations when determining the fitted height range of the scanning points on the i^{th} row of the scanning line based on the fitted height of the target point Si,q:
obtain the fitted heights of multiple target points in the neighborhood window centered on the target point Si,q;
obtain the fitted height fluctuation value based on the fitted heights of multiple target points in the neighborhood window;
determine the fitted height range of the target point Si,q based on the fitted height and the fitted height fluctuation value of the target point Si,q; and
determine the fitted height range of the non-target point Si,q based on the fitted height range of the target point Si,q; the non-target points are the scanning points on the i^{th} row of the scanning line other than the target points, p is a positive integer, and the sum of q and p is the total number of scanning points on the i^{th} row of the scanning line.

In an embodiment, the chip 120 performs the following operations when fitting the target point Si,q to obtain the fitted height:
obtain the heights of multiple target points in the neighborhood window centered on the target point Si,q; and
perform linear fitting based on the heights of the multiple target points in the neighborhood window to obtain the fitted height of the target point.

Embodiments of this application also provides a computer-readable storage medium, which stores at least one instruction that, when executed by a processor, implements the LiDAR detection method described in the above embodiments.

Embodiments of this application also provides a computer program product, which stores at least one instruction that, when loaded and executed by a processor, implements the LiDAR detection method described in the above embodiments.

In one or more of the above embodiments, the functions described in the embodiments of this application can be implemented in hardware, software, firmware, or any combination thereof. When implemented in software, these functions can be stored on a non-transitory computer-readable medium or transmitted as one or more instructions or code on a non-transitory computer-readable medium. A non-transitory computer-readable medium includes computer storage media and communication media, where the communication media includes any medium that facilitates the transfer of a computer program from one place to another. Storage media can be any available medium that can be accessed by a general-purpose or special-purpose computer.

What is claimed is:

1. A LiDAR detection method, comprising:
obtaining point cloud data corresponding to an i−1^{th} ground line and point cloud data corresponding to an i−2^{th} ground line, wherein i is an integer greater than or equal to 3;
calculating a predicted height range of an i^{th} ground line based on the point cloud data corresponding to the i−1^{th} ground line and the point cloud data corresponding to the i−2^{th} ground line;
determining a target point in scanning points by detecting a scanning point of an i^{th} row of a scanning line based on the predicted height range; and
obtaining the i^{th} ground line based on the target point, wherein a distance between the ground line and the LiDAR increases from the i−2^{th} ground line, to the i−1^{th} ground line, and to the i^{th} ground line.

2. The LiDAR detection method according to claim 1, wherein the calculating the predicted height range of the i^{th} ground line based on the point cloud data corresponding to the i−1^{th} ground line and the point cloud data corresponding to the i−2^{th} ground line comprises:
traversing a scanning point of the i−1^{th} ground line and a scanning point of the i−2^{th} ground line to obtain K pairs of points, wherein one pair of points comprises a first reference point and a second reference point, the first reference point is a scanning point of the i−1^{th} ground line, the second reference point is a scanning point of the i−2^{th} ground line, and a difference between pitch angles of the first reference point and the second reference point is less than or equal to a threshold, wherein K is a positive integer; and
based on heights of the first reference point and the second reference point in the pairs of points, calculating a predicted height range of a first scanning point, wherein the first scanning point is a scanning point of the i^{th} row of the scanning line, and pitch angle differences of the K pairs of points are less than or equal to the threshold, and a scanning point of the i^{th} row of the scanning line other than the first scanning point is a second scanning point; and
based on the predicted height range of the first scanning point, calculating a predicted height range of the second scanning point.

3. The LiDAR detection method according to claim 2, wherein based on heights of the first reference point and the second reference point in the pairs of points, the calculating a predicted height range of a first scanning point comprises:
obtaining a height fluctuation value of K first reference points in the K pairs of points and a gradient value of a point pair corresponding to the first scanning point; and
based on the height fluctuation value and the gradient value, calculating the predicted height range of the first scanning point.

4. The LiDAR detection method according to claim 2, wherein based on the predicted height range of the first scanning point, the calculating a predicted height range of the second scanning point comprises:
determining at least two first scanning points adjacent to the second scanning point on the i^{th} row of the scanning line; and
based on the predicted height ranges of the at least two first scanning points adjacent to the second scanning point, calculating the predicted height range of the second scanning point.

5. The LiDAR detection method according to claim 1, wherein the determining a target point in scanning points by detecting a scanning point of an i^{th} row of a scanning line based on the predicted height range comprises:
obtaining heights of a plurality of scanning points in a neighborhood window with a scanning point Si,j as a center, wherein j is a positive integer and less than or equal to a total number of the scanning points on the i^{th} row of the scanning line;
comparing the heights of the plurality of scanning points in the neighborhood window with the predicted height range of the scanning point Si,j to determine whether the scanning point Si,j is a ground point; and
when the scanning point is the ground point, determining the scanning point as the target point.

6. The LiDAR detection method according to claim 5, wherein the comparing the heights of the plurality of scanning points in the neighborhood window with the predicted height range of the scanning point Si,j to determine whether the scanning point Si,j is a ground point, comprises:
determining the scanning point Si,j as the ground point, when the height of the scanning point Si,j is within the predicted height range of the scanning point Si,j, and a quantity of the plurality of scanning points in the neighborhood window whose heights are within the predicted height range of the scanning point Si,j is greater than a first threshold; and
determining the scanning point Si,j as the ground point, when the height of the scanning point Si,j is not within the predicted height range of the scanning point Si,j and a quantity of the plurality of scanning points in the neighborhood window whose heights are within the predicted height range of the scanning point Si,j is greater than a second threshold.

7. The LiDAR detection method according to claim 1, wherein the obtaining the i^{th} ground line based on the target point comprises:
performing fitting on the target point Si,q to obtain a fitted height, wherein q is a positive integer and less than or equal to a total number of the target points on the i^{th} row of the scanning line; and
obtaining the i^{th} ground line based on the fitted height.

8. The LiDAR detection method according to claim 7, wherein after performing fitting on the target point Si,q to obtain a fitted height, the method further comprises:
based on the fitted height of the target point Si,q, determining a fitted height range of the scanning point of the i^{th} row of the scanning line; and
using the fitted height range of the scanning point of the i^{th} row of the scanning line as the predicted height range and counting, and returning to perform the step of detecting the scanning point of the i^{th} row of the scanning line based on the predicted height range and determining the target point in the scanning point until a value of the counting is greater than a preset number.

9. The LiDAR detection method according to claim 8, wherein the based on the fitted height of the target point Si,q, determining a fitted height range of the scanning point of the i^{th} row of the scanning line comprises:
obtaining fitted heights of a plurality of target points in a neighborhood window with the target point Si,q as a center; and
based on the fitted heights of the plurality of target points in the neighborhood window, obtaining a height fluctuation value of the fitted heights, and determining a fitted height range of the target point Si,q, and determining a fitted height range of a non-target point Si,p, wherein the non-target point is a scanning point on the i^{th} row of the scanning line other than the target point, p is a positive integer, and a sum of q and p is the total number of the scanning points on the i^{th} row of the scanning line.

10. The LiDAR detection method according to claim 7, wherein the performing fitting on the target point Si,q to obtain the fitted height comprises:
obtaining heights of a plurality of target points in a neighborhood window with the target point Si,q as a center; and
performing linear fitting based on the heights of the plurality of target points in the neighborhood window to obtain the fitted height of the target point Si,q.

11. A LiDAR detection device, comprising:
a data obtaining module, configured to obtain point cloud data corresponding to an i−1^{th} ground line and point cloud data corresponding to an i−2^{th} ground line, wherein i is an integer greater than or equal to 3;
a height calculation module, configured to calculate a predicted height range of the i^{th} ground line based on the point cloud data corresponding to the i−1^{th} ground line and the point cloud data corresponding to the i−2^{th} ground line;
a data detection module, configured to detect a scanning point of an i^{th} row of a scanning line based on the predicted height range to determine a target point in the scanning point; and
a data generation module, configured to obtain the i^{th} ground line based on the target point, wherein the i^{th} ground line, the i−2^{th} ground line, the i−1^{th} ground line, and the LiDAR are in order from nearest to far.

12. A LiDAR, comprising a processor and a memory, wherein the memory stores a computer program, and the computer program is capable of being loaded by the processor to perform steps of a LiDAR detection method, the LiDAR detection method comprises:
obtaining point cloud data corresponding to an i−1^{th} ground line and point cloud data corresponding to an i−2^{th} ground line, wherein i is an integer greater than or equal to 3;
calculating a predicted height range of an i^{th} ground line based on the point cloud data corresponding to the i−1^{th} ground line and the point cloud data corresponding to the i−2^{th} ground line;
determining a target point in scanning points by detecting a scanning point of an i^{th} row of a scanning line based on the predicted height range; and
obtaining the i^{th} ground line based on the target point, wherein a distance between the ground line and the LiDAR increases from the i−2^{th} ground line, to the i−1^{th} ground line, and to the i^{th} ground line.
